(19) United States
(12) Patent Application Publication
(10) Pub. No.: US 2010/0036189 A1
(43) Pub. Date: Feb. 11, 2010

(54) PROCESS FOR THE CAPTURE AND DEHALOGENATION OF HALOGENATED HYDROCARBONS

(75) Inventors: Matthew Joseph Lee, New South Wales (AU); Ralf Cord-Ruwischi, Western Australia (AU)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: ENVIRONMENTAL BIOTECHNOLOGY CRC PTY LIMITED, Eveleigh, NSW (AU)

(21) Appl. No.: 12/516,833

(22) PCT Filed: Nov. 29, 2007
(86) PCT No.: PCT/AU07/01848

§ 371 Date: Oct. 12, 2009

(30) Foreign Application Priority Data
Nov. 30, 2006 (AU) 2006906721

(51) Int. Cl. A62D 3/37

(52) U.S. Cl. 588/316

(57) ABSTRACT

The present invention relates to a process for dehalogenation of a halogenated hydrocarbon comprising: desorbing a halogenated hydrocarbon from a solid phase using a solvent; and dehalogenating the halogenated hydrocarbon in a solvent which comprises the solvent used in the desorption step.

### TECHNICAL FIELD

The present invention relates to a process for the capture and subsequent dehalogenation of halogenated hydrocarbons.

### BACKGROUND OF THE INVENTION

Contamination of various sites such as subsurface soils with halogenated hydrocarbons is a significant problem in many parts of the world. Discharge of volatile halogenated organic compounds into the soil has lead to contamination of aquifers resulting in potential public health impacts and degradation of groundwater resources, thereby limiting future use. The threat that halogenated hydrocarbons pose as a result of their toxicity means that contaminated sites need to be effectively decontaminated and the halogenated hydrocarbons dehalogenated accordingly.

In areas where subsurface soil is contaminated with halogenated hydrocarbons, the halogenated hydrocarbons may be removed from the ground and then subjected to a dehalogenation reaction.

The present inventors have developed a convenient and efficient process for the removal of halogenated hydrocarbons from a site which facilitates the subsequent dehalogenation step.

### SUMMARY OF THE INVENTION

The present invention provides a process for dehalogenation of a halogenated hydrocarbon, said process comprising:

(i) desorbing a halogenated hydrocarbon from a solid phase using a solvent; and

(ii) dehalogenating the halogenated hydrocarbon in a solvent which comprises the solvent used in step (i).

The solid phase may be a non-polar solid phase.

The solid phase may be other than soil.

The solid phase may be activated carbon, or other suitable phase that adsorbs the halogenated hydrocarbon, or mixture thereof.

The solvent may be a protic solvent or an aqueous solvent mixture.

The halogenated hydrocarbon may be a volatile halogenated hydrocarbon.

The halogenated hydrocarbon may be a chlorinated hydrocarbon which may be volatile.

Step (ii) may be carried out in the presence of an electron mediator.

Step (ii) may be performed at acidic pH.

The electron mediator may be vitamin B₁₂ (VB₁₂), or an analogue or derivative thereof.

The aqueous solvent mixture may be a mixture of water and an organic solvent that is miscible with water, for example tetrahydrofuran, ethanol, methanol, propanol, isopropanol, acetonitrile, triethylamine, diethylamine, trimethylamine or dimethylformamide.

The mixture of water and the organic solvent may comprise between about 60% and about 99% of the organic solvent (v/v).

The mixture of water and the organic solvent may comprise between about 80% and about 95% of the organic solvent (v/v).

The mixture of water and the organic solvent may be an alcohol/water mixture.

The alcohol may be an alcohol having between 1 and 10 carbon atoms, or between 1 and 6 carbon atoms, for example, methanol, ethanol, propanol, isopropanol, butanol, t-butanol, pentanol, hexanol, or mixtures thereof.

The alcohol/water mixture may comprise between about 60% and about 99% alcohol (v/v).

The alcohol/water mixture may comprise between about 80% and about 95% alcohol (v/v).

The solvent of step (i) may comprise the electron mediator.

The solvent of step (ii) may be reused subsequently when the process is repeated.

The solid phase may be reused subsequently when the process is repeated.

The dehalogenation in step (ii) may be carried out using a zero-valent transition metal, for example iron or zinc.

The dehalogenation in step (ii) may be carried out using borohydride.

The process may further comprise removing the halogenated hydrocarbon from an environment, for example an environment comprising soil, such that it becomes adsorbed to the solid phase.

### BRIEF DESCRIPTION OF THE DRAWINGS

A preferred embodiment of the present invention will now be described, by way of example only, with reference to the accompanying drawings wherein:

FIG. 1 shows the concentration of hexachlorobuta-1,3-diene in neat ethanol (♦) and ethanol/water 90/10 (▪) extracts of hexachlorobuta-1,3-diene enriched activated carbon.

FIG. 2 shows an apparatus for purging and trapping a halogenated hydrocarbon.

FIG. 3 shows the formation and depletion of chlorinated species of 1,3-butadiene after reaction with zinc: hexachloro-1,3-butadiene (◯), pentachoro-1,3-butadienes (+), tetrachloro-1,3-butadiene (Δ), trichloro-1,3-butadienes (□), dichloro-1,3-butadienes (♦).

FIG. 4 shows rates of hexachlorobuta-1,3-diene reduction (disappearance) in stirred (⊙) versus static (□) reaction mixtures.

FIG. 5 shows the reductive dechlorination rates of hexachlorobuta-1,3-diene with varying molar ratios (mol %) of VB₁₂.

FIG. 6 shows reduction rate of hexachlorobuta-1,3-diene with varying molar ratios of zinc. The experiment was carried out on an orbital shaker (at 80 rpm) for improved mass transfer. The zinc powder was not kept suspended, but rather was “caked” onto the bottom of the reaction vessel.

FIG. 7 shows the sum of all detectable chlorinated C₄ compounds with varying molar ratios of zinc to hexachlorobuta-1,3-diene. □(0), ▪ (0.5), ▴ (1) X (2), ◯ (5), ♦ (10), + (15). VB₁₂ concentration was 0.04 mM.

FIG. 8 shows HCBD reduction (disappearance) at 20° C. (♦), 37° C. (▪) and 55° C. (▴).

FIG. 9 shows the effect of decreasing pH on the rate of hexachlorobuta-1,3-diene dechlorination. pH= 7 (0 mM NH₄⁺) (▪) pH= 5 (100 mM NH₄⁺) (♦).

FIG. 10 shows reduction of HCBD with borohydride in the presence of VB₁₂.

FIG. 11 shows a comparison of zinc reduction of hexachlorobuta-1,3-diene mediated by phenazine (▴), VB₁₂ (▪) and 3-amino-7-dimethylamino-2-methylphenazine (neutral red) (♦).

FIG. 12 shows production of methane and C₂ hydrocarbons in the zinc driven reduction of carbon tetrachloride and perchloroethylene.

FIG. 13 shows the reaction of hexachlorobuta-1,3-diene with zinc in the presence of VB₁₂ in the following solvents Dimethylformamide (▴), isopropanol (♦), acetonitrile () and acetone (▪).

FIG. 14 shows the reduction of hexachlorobuta-1,3-diene by reaction with zinc in the presence of anthraquinone-2,6-disulfonate (error bars represent standard deviation from the mean n= 2).

FIG. 15 shows an apparatus in which the process of the invention may be carried out.

### DEFINITIONS

The following are some definitions that may be helpful in understanding the description of the present invention. These are intended as general definitions and should in no way limit the scope of the present invention to those terms alone, but are put forth for a better understanding of the following description.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of elements or integers. Thus, in the context of this specification, the term “comprising” means “including principally, but not necessarily solely”.

The term “volatile halogenated hydrocarbon” as used herein refers to halogenated

hydrocarbons that have a Henry's law constant of greater than 10⁻⁷ atm-m³/mol at standard temperature and pressure (1 arm and 298 K).

The term “miscible” as used herein refers to liquids that are capable of being mixed together in any concentration without a separation of phases occurring.

### DETAILED DESCRIPTION OF THE INVENTION

The process of the invention is applicable to a wide range of halogenated hydrocarbons, indeed any halogenated hydrocarbon that is able to be reversibly adsorbed onto the solid phase. Examples of halogenated hydrocarbons include, but are not limited to: chlorinated solvents such as chloroform, carbon tetrachloride, trichloroethylene (TCE), vinyl chloride, tetrachloroethylene (PCE), dichloroethane, dichloromethane, chloroethane, 1,1,1-trichloroethane, 1,1,2,2-tetrachloroethane, pentachloroethane, chloropropane, chlorobutane, chloropentane, 3-chloromethylheptane, chlorooctane, chloroethylene, chloropropene, hexachlorobuta-1,3-diene (HCBD), chlorobenzenes (in particular dichlorobenzene and hexachlorobenzene), chlorotoluenes, α,α,α-trichlorotoluene, chloroxylenes, polychlorinated biphenyls (PCB's), chlorophenols, octochlorostwene, brominated solvents such as bromoform, bromoethane, tetrabromoethane, carbon tetrabromide, bromopropane, bromobutane, bromobenzene, bromopentane, polybrominated biphenyls and polybrominated biphenyl ethers, other halogenated solvents such as iodobenzene, 1-bromo-2-chloroethane, and 1-chloro-1,1-difluoroethane. The halogenated hydrocarbon may be adsorbed to the solid phase by either passing a liquid comprising the halogenated hydrocarbon through a filter comprising the solid phase, or alternatively by creating an environment where the halogenated hydrocarbon is vapourised in the presence of a trap or filter comprising the solid phase such that the halogenated hydrocarbon becomes adsorbed accordingly. Halogenated hydrocarbons of particular interest may be volatile halogenated hydrocarbons.

The solid phase may be any substance that is capable of reversibly adsorbing halogenated hydrocarbons. Examples of suitable solid phases include, but are not limited to: activated carbon, styrene-based adsorbent (XAD2®, Supelco), silica, for example C18 silica, zeolites, amberlite, tenax, diatomaceous earth and charcoal. In one embodiment, the solid phase is activated carbon. The solid phase may be a pure substance, for example charcoal as opposed to a mixture of substances such as soil.

In an embodiment of the invention, volatile halogenated hydrocarbons may be adsorbed to the solid phase by heating a contaminated site in a substantially closed system in the presence of filters comprising the solid phase. For example, hot air may be injected into contaminated soil as it is being churned by a soil agitating device, such as a chain trencher. The volatile halogenated hydrocarbons released are then captured by the filters comprising the solid phase. In another embodiment of the invention, the hot air may be replaced by a suitable vacuum system, wherein the vacuum system draws the halogenated hydrocarbons into a chamber comprising the solid phase. In this particular embodiment, the soil may or may not be agitated.

The desorption of the halogenated hydrocarbon from the solid phase may be achieved simply by flushing the solid phase with an appropriate solvent. The solvent may be a protic solvent or an aqueous solvent mixture. The aqueous solvent mixture may be a mixture of water and an organic solvent that is miscible with water, wherein the amount of the organic solvent is between (v/v): 10% to 99%, 15% to 99%, 20% to 99%, 25% to 99%, 30 to 99%, 35% to 99%, 40% to 95%, 45% to 95%, 50% to 95%, 55% to 95%, 60% to 95%, 65 to 95%, 70% to 95%, 75% to 95%, 77% to 95%, 79% to 95%, 81% to 95%, 83% to 95%, 85% to 95%, 86% to 95%, 87% to 95%, 88% to 95%, 89% to 95%, 90% to 95%, 85% to 99%, 88% to 99%, 90% to 99%, or 92% to 98%. The organic solvent in the above embodiment may be an alcohol, for example ethanol.

The protic solvent may be an alcohol, which may be in admixture with another solvent, for example tetrahydrofuran. Mixtures of lower alcohols and ether solvents such as THF are known to be useful media for dehalogenation of most kinds of halogenated hydrocarbons.

A person of skill in the art would, by routine trial and experimentation, be able to determine the amount of solvent required to remove substantially all of the adsorbed halogenated hydrocarbon from the solid phase. As an example, where the solid phase is activated carbon, the amount of solvent that may be required to remove substantially all of the adsorbed halogenated hydrocarbon is approximately 10 mL for a cylindrical trap having a length of 5 cm and a diameter of 2 mm.

Because step (i) of the process of the invention is capable of desorbing substantially all of the adsorbed halogenated hydrocarbons from the solid phase, the solid phase may be continuously reused when the process of the invention is repeated. Where the solid phase is activated carbon, step (i) of the process of the invention is capable of desorbing about 99% of the adsorbed halogenated hydrocarbons, meaning that the activated carbon may be continuously reused many times through the process of the invention.

In the process of the present invention, the dehalogenation may be conveniently carried out in the same solvent or solvent system in which the desorption in step (i) is performed. As such, it is not necessary to remove the solvent or solvent system following the desorption step and then introduce a new solvent or solvent system for the subsequent dehalogenation reaction. This saves considerable time and expense when the process is performed on an industrial scale.

Dehalogenation of the halogenated hydrocarbon may be carried out by methods known to those skilled in the art. Suitable dehalogenation methods include reductive dehalogenation using an appropriate zero-valent metal. Metals that are suitable for the dehalogenation include transition metals and mixtures thereof. Sodium may also be used for dehalogenation where the solvent does not include a significant water content. In principal, any metal with a redox potential of approximately −800 mV may be used for the dehalogenation reaction. In one embodiment of the invention, the zero-valent metal is zinc. The metal may be in the form of a powder, or alternatively may be in the form of turnings, chunks or nanoparticles.

In an alternative embodiment, the dehalogenation step may be performed using a suitable hydride source, such as borohydride. The borohydride may be an alkali metal borohydride or an alkaline earth metal borohydride, or other suitable borohydride. Examples include sodium borohydride, lithium borohydride, potassium borohydride, calcium borohydride, magnesium borohydride, ammonium borohydride, tetramethylammonium borohydride and any mixture thereof. The hydride source should be compatible with aqueous conditions.

The amount of metal required to achieve essentially complete dehalogenation (i.e greater than about 98%) of the halogenated hydrocarbon may be between about 1.6 and about 2.0 equivalents of metal for each halogen present in the halogenated hydrocarbon. For example, in the case of HCBD, about 10 equivalents of zinc may be required in order to achieve essentially complete dehalogenation.

When performing the dehalogenation step, the reaction mixture may be stirred or agitated. This has been found to result in an increase in the rate of dehalogenation as compared to when the reaction is allowed to proceed in a static state in the absence of agitation.

The dehalogenation step may be performed in an inert atmosphere, wherein oxygen is excluded or substantially excluded. Substantially excluded includes less than 8% v/v, 7% v/v, 6% v/v, 5% v/v, 4% v/v, 3% v/v, 2% v/v, 1% v/v, 0.5% v/v, for example between 8% and 0.01% etc, wherein the gas in which the oxygen is substantially excluded may be for example, nitrogen, argon, helium, CO₂ or xenon, or any mixture of two or more thereof.

The dehalogenation step may be performed at ambient temperature (about 20° C. to 25° C.), or alternatively the dehalogenation step may be carried out at a temperature of 25 between about 30° C. and 125° C., or between about 30° C. and 115° C., or between about 30° C. and 105° C., or between about 30° C. and 95° C., or between 35° C. and 70° C., or between 35° C. and 65° C., or between 35° C. and 60° C., or between 35° C. and 55° C., or between 35° C. and 50° C., or between 40° C. and 50° C., or between 35° C. and 75° C., or between 40° C. and 75° C., or between 45° C. and 75° C., or between 45° C. and 65° C. Performing the dehalogenation step at a temperature of about 35° C. to 55° C. may result in up to a two-fold increase in the rate of dehalogenation compared to performing the dehalogenation at ambient temperature.

The dehalogenation step (step (ii)) may also be performed at an acidic pH. For example, the dehalogenation step may be performed at a pH of between about 2 and about 6.5, or between about 2.5 and about 6.5, or between about 2.8 and about 6, or between about 3 and about 6, or between about 3.2 and about 6, or between about 3.2 and about 5.8, or between about 3.5 and about 5.5, or between about 4 and about 5.5, or between about 4.5 and about 5.5, or at a pH of about 5.

An electron mediator may also be added to the dehalogenation step (step (ii)). In one embodiment, the electron mediator may be added to an aqueous solvent mixture employed in step (i). The electron mediator that may be added is a substance that facilitates the transfer of electrons from the metal to the halogenated hydrocarbon. Such electron mediators increase the rate of the dehalogenation reaction. Suitable electron mediators include compounds that facilitate the transfer of electrons from the metal to the halogenated hydrocarbon. The electron mediator may be a transition metal complex.

The electron mediator may be VB₁₂ or a derivative or analogue thereof. Derivatives of VB₁₂ for use as electron mediators include the anilide, ethylamide, monocarboxylic and dicarboxylic acid derivatives of VB₁₂ and its analogues, and also tricarboxylic acid or propionamide derivatives of VB₁₂ or its analogues. Suitable VB₁₂ derivatives also include molecules in which alterations or substitutions have been made to the Corrin ring (for example -cyano (13-epi) cobalamin Co a-(a 5,6-dimethylbenzimidazoyl)-Co, b-cyano-(13-epi) cobamic a,b,c,d,g, pentaamide, adenosyl-10-chlorocobalamin, dicyanobyrinic heptamethyl ester, cyanoaquacobyrinic acid pentaamide), or where cobalt is replaced by another metal ion (for example nickel or zinc, etc) or various anion or alkyl substituents to the corrin ring. Derivatives and analogues of VB₁₂ are discussed in Schneider, Z. and Stroinski, A.; Comprehensive VB₁₂; Walter De Gruyter; Berlin, N.Y.: 1987, the disclosure of which is incorporated herein by reference. In an alternative embodiment, the electron mediator may include a quinone moiety, for example anthraquinone-2,6-disulfonate. In another alternative embodiment, the electron mediator may be cobaloxime. In a further alternative embodiment, the electron mediator may be a compound including a phenazine moiety, for example 3-amino-7-dimethylamino-2-methylphenazine (neutral red). Further electron mediators that may be used include Jacobsen's catalyst (Co salen), cobalt acetylacetone and compounds 1 and 2 below.

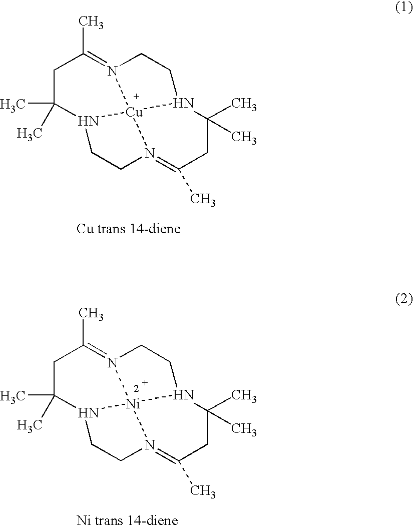

The amount of the electron mediator added to the dehalogenation reaction may be between 0.0005 mol % and 100 mol %, or between 0.005 mol % and 50 mol %, or between 0.005 mol % and 45 mol %, or between 0.005 mol % and 40 mol %, or between 0.005 mol % and 30 mol %, or between 0.005 mol % and 20 mol %, or between 0.01 mol % and 15 mol %, or between 0.01 mol % and 10 mol %, or between 0.01 mol % and 5 mol %, or between 0.05 mol % and 3 mol %, or between 0.1 mol % and 2 mol % of the amount of halogenated hydrocarbon to be dehalogenated.

The electron mediator may be recycled through the process of the invention together with the solvent. It has been found that VB)₂ can be recycled through the process of the invention up to 10 times.

In an embodiment of the invention, the solvent employed in step (i) that is used to desorb the solid phase comprises the electron mediator, such that following step (i), step (ii) is performed by simply adding the appropriate metal to the mixture obtained from step (i) so as to dehalogenate the halogenated hydrocarbon.

When used for dehalogenating volatile halogenated hydrocarbons with zinc metal and/or iron for example, the usual products of the reaction are a gaseous hydrocarbon, zinc or iron hydroxide and zinc or iron chloride. As such, the solvent system used in the process can be continually recycled, such that the process is sustainable with respect to the solvent system, and as noted above, the solid phase.

A further advantage associated with the process of the present invention is that when performing step (ii) with a combination of zinc, VB₁₂ and 10% water in ethanol, many fold higher reaction rates are observed as compared to rates observed when either of the three components are omitted. The combination of zinc, VB₁₂ and 10% water in ethanol may be synergistic.

A representation of one embodiment of the process of the invention is given below:

Step 1: Desorb halogenated hydrocarbon (for example hexachlorobuta-1,3-diene) from solid phase (for example, activated carbon) using alcohol/water mixture (wherein the alcohol may be ethanol) comprising the electron mediator (for example VB₁₂).

Step 2: A zero-valent metal (for example zinc) is added the alcohol/water mixture comprising the halogenated hydrocarbon.

Step 3: The following reaction takes place in the ethanol/water mixture, wherein an electron is transferred to the halogenated hydrocarbon, this step being mediated by VB₁₂:

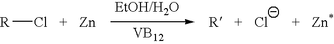

Step 4: The following reaction then takes place in the alcohol/water mixture, wherein the hydrocarbon radical R abstracts a proton from the solvent:

R^{}+R′—OH+Cl^{\hat{-}}+Zn^{}→R—H+R′—O^{}+Cl^{\hat{-}Zn}^{}
wherein R′ is H or Et

Step 5: The alcohol/water mixture comprising the inorganic reaction byproducts zinc hydroxide and/or zinc ethoxide and chloride ion (and possibly some of the resultant hydrocarbon R—H which may not have evaporated during the reaction) is reused in steps 1 to 4, or alternatively at least some of the inorganic byproducts in the alcohol/water mixture (and/or the dehalogenated hydrocarbon) may be removed if necessary prior to being reused in steps 1 to 4. The inorganic byproducts may be removed by distilling the alcohol/water mixture comprising the inorganic byproducts, or alternatively by passing the alcohol/water mixture comprising the inorganic byproducts through an ion exchange column.

### MODES FOR CARRYING OUT THE INVENTION

The process of the invention may be carried out by adsorbing a halogenated hydrocarbon, for example a chlorinated hydrocarbon such as hexachlorobenzene, to the solid phase, which may for example be activated carbon. The adsorption may be carried out using a vacuum system which draws the halogenated hydrocarbon from a contaminated site, which may for example be soil, into a chamber comprising the solid phase, wherein the halogenated hydrocarbon becomes adsorbed thereto. The soil may or may not be agitated. As an alternative, the halogenated hydrocarbon may be adsorbed to the solid phase by injection of hot air into contaminated soil as it is being churned by a soil agitating device, for example a chain trencher.

Once the halogenated hydrocarbon has been adsorbed onto the solid phase, it is then desorbed with a solvent, for example an aqueous solvent mixture. The aqueous solvent mixture may be a C₁-C₆ alcohol such as ethanol. The amount of ethanol in the aqueous solvent mixture may be between about 80% and 98% (v/v), or alternatively between about 85% and about 95% (v/v). The aqueous solvent mixture may comprise the electron mediator, which, for example may be VB₁₂ or a compound comprising a quinone moiety, in an amount of between about 0.5 and 5 mol % as compared to the amount of the halogenated hydrocarbon. As such, the electron mediator may already be present in the aqueous solvent mixture when the mixture is used for desorbing the halogenated hydrocarbon.

The dehalogenation of the halogenated hydrocarbon is performed in the aqueous solvent mixture which comprises the aqueous solvent mixture used for desorbing the halogenated hydrocarbon from the solid phase. As such, on the vast majority of occasions when performing the process, the only action needed to commence dehalogenation following desorption is the addition of the reducing agent to the aqueous solvent mixture.

The dehalogenation reaction may be performed by adding an appropriate zero-valent metal, such as zinc or iron, or a borohydride such as sodium or lithium borohydride to the aqueous solvent mixture comprising the halogenated hydrocarbon. The amount of zero-valent metal employed in the dehalogenation may be between about 1.4 and 1.7 equivalents per halogen. The dehalogenation reaction may be stirred, and may also be heated to a temperature of between about 35° C. to about 55° C. An electron mediator such as VB₁₂ may also be added.

On completion of the dehalogenation reaction, the aqueous solvent mixture, and

also the solid phase, may be reused many times when the process is repeated. Where the process is repeated many times and where an aqueous solvent mixture is used, it may be necessary, on occasions, to add water to the recycled aqueous solvent mixture.

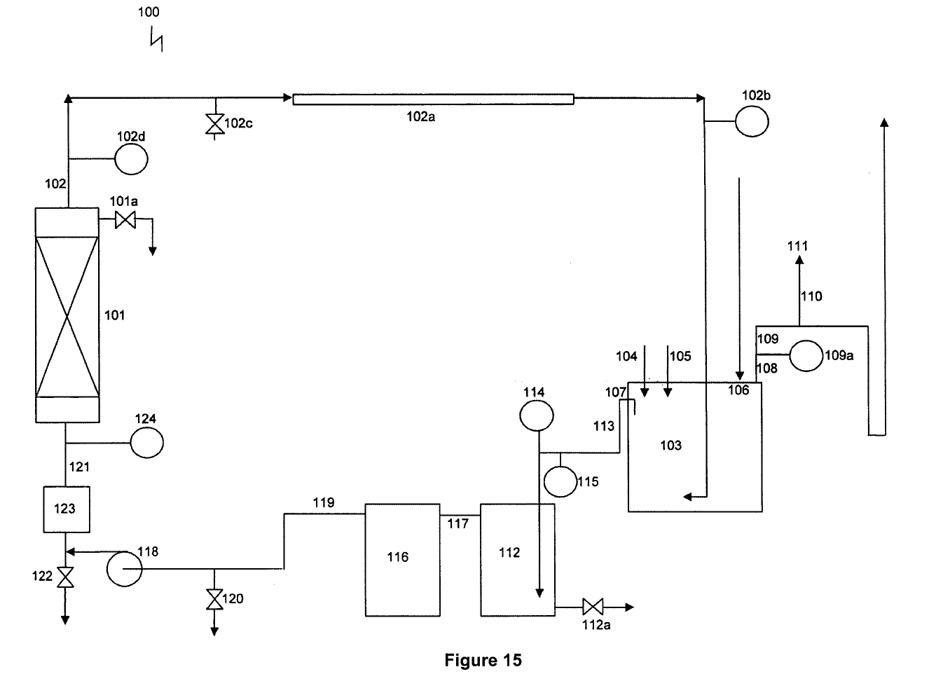

FIG. 15 shows an apparatus in which the process of the invention may be performed. Apparatus 100 includes desorption vessel 101 adapted to receive a solid phase to which halogenated hydrocarbons are adsorbed. Desorption vessel 101 includes overflow valve 101a, which may be used for draining displaced solvent whilst filing the desorption vessel 101 with the solid phase if necessary. Desorption vessel 101 is in fluid communication with reaction vessel 103 via pipe 102, which may be made of oxygen impermeable rubber (along with all other piping in apparatus 100). A section of pipe 102 is immersed in a hot water bath 102a so as to heat the solvent moving therethrough. Pipe 102 also comprises temperature gauge 102b which monitors the temperature of the solvent in pipe 102 once it has exited the portion of pipe 102 which is immersed in water bath 102a. Pipe 102 further includes pressure indicator 102d adapted to monitor the build up of pressure in pipe 102 caused by the evolution of hydrogen gas and hydrocarbon gases, and valve 102c which allows sampling of the solvent travelling through pipe 102. Reaction vessel 103, where the dehalogenation reaction occurs, is equipped with stirring means and inlets 104 and 105, where the solvent in which dehalogenation is to be performed and the reducing agent (and electron mediator if desired) are introduced into reaction vessel 103. Reaction vessel 103 is also equipped with an inlet 106, which is adapted to provide inert gas to reaction vessel 103 if desired. Reaction vessel 103 also includes outlets 107 and 108. Outlet 108 permits the flow of gas produced in the reaction vessel 103 during dehalogenation to the atmosphere via pipe 109. Pipe 109 is in communication with pipe 110 which is connected to a gas sampling point 111, which may be, for example, a tedlar Bag™. Outlet 107 permits flow of solvent from reaction vessel 103 to settling vessel 112 via pipe 113. Pipe 113 is additionally fitted with a pH indicator 114 and a dissolved oxygen indicator 115. Settling vessel 112 is in fluid communication with overflow vessel 116 via pipe 117. Settling vessel 112 includes valve 112a which facilitates draining of the solvent where necessary to recover reducing agent (for example zinc) that may have traveled from reaction vessel 103, or any other insoluble material. Metering pump 118 is in fluid communication with overflow vessel 116 via pipe 119. Pipe 119 is fitted with valve 120 which allows sampling of the solvent travelling through pipe 119 for monitoring levels of dissolved halogenated hydrocarbons. Metering pump 118 provides solvent to desorption vessel 101 via pipe 121, and indeed facilitates movement of solvent throughout the entire apparatus. Pipe 121 may be fitted with valve 122 which may be used to bleed salt water if necessary. Pipe 121 may also include flow dampener 123 and pressure indicator 124. The flow dampener 123 may additionally include a pH indicator and/or a dissolved oxygen indicator.

In use, desorption vessel 101 is charged with a solid phase, for example granulated activated carbon to which a halogenated hydrocarbon is adsorbed. Reaction vessel 103 is charged with solvent, reducing agent, and if desired an electron mediator (for example the a combination of: 90% ethanol containing 20 μM VB₁₂ and zinc pieces (2-14 mesh)). Metering pump 118 is activated and solvent is drawn from reaction vessel 103 to settling vessel 112 via outlet 107 and pipe 113. As the solvent level rises in settling vessel 112, solvent travels via pipe 117 to overflow vessel 116. The settling tank 112 and the overflow vessel 116 permit settling of solid material (for example metal pieces and any insoluble inorganic salts). From overflow vessel 116, the solvent travels via flow dampener 123 into desorption vessel 101, wherein desorption of the halogenated hydrcarbons adsorbed to the solid phase occurs. On exiting desoprtion vessel 101, the solvent, which now comprises dissolved halogenated hydrocarbons, travels through pipe 102, via water bath 102a into reaction vessel 103. The dehalogenation reaction of the desorbed hydrocarbons occurs in reaction vessel 103 in the presence of the reducing agent, and if present, the electron mediator, thereby producing inorganic salts and hydrocarbons. The insoluble inorganic salts may settle at the bottom of reaction vessel 103, and also at the bottom of settling tank 112 and the overflow vessel 116. Gas produced in the dehalogenation reaction exits reaction vessel 103 via pipe 109, and may be sampled at gas sampling point 111. Once the solvent has returned to reaction vessel 103, it is once again pumped via settling tank 112 and the overflow vessel 116 through is desorption vessel 101. Once all of the halogenated hydrocarbon has been desorbed and subsequently dehalogenated, a fresh supply of solid phase to which a halogenated hydrocarbon is adsorbed may be loaded into desorption vessel 101 and the process repeated. The solvent may be recycled repeatedly in the process.

### EXAMPLES

The invention will now be described in more detail, by way of illustration only,

with respect to the following examples. The examples are intended to serve to illustrate this invention and should not be construed as limiting the generality of the disclosure of the description throughout this specification.

### Example 1

### Removal of HCBD from Activated Carbon with Ethanol/Water

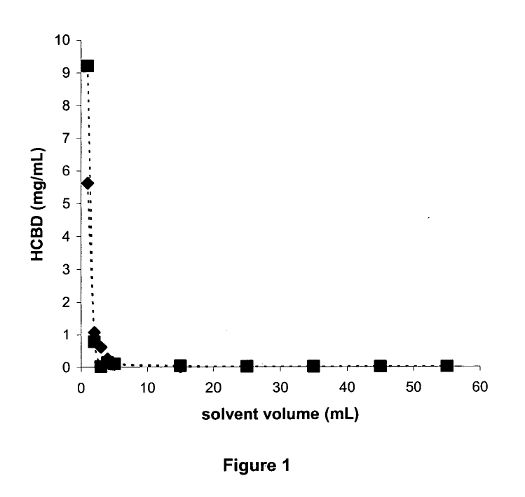

HCBD-enriched activated carbon (comprising about 30 mg of HCBD) was packed into stainless steel Swage Lock tubing thus simulating an activated carbon trap loaded with HCBD (the activated carbon was powdered (60 mesh) obtained from Sigma-Aldrich, Milwaukee, Wis.). In two attempts at removing the HCBD from the activated carbon the traps were attached to a HPLC pump and purged with 100% ethanol and an ethanol/water mixture (90%) (see FIG. 1). In both cases, greater than 99% of the HCBD was removed in the first 50 ml of eluant.

### Example 2

### Recycling of Activated Carbon with Ethanol/Water

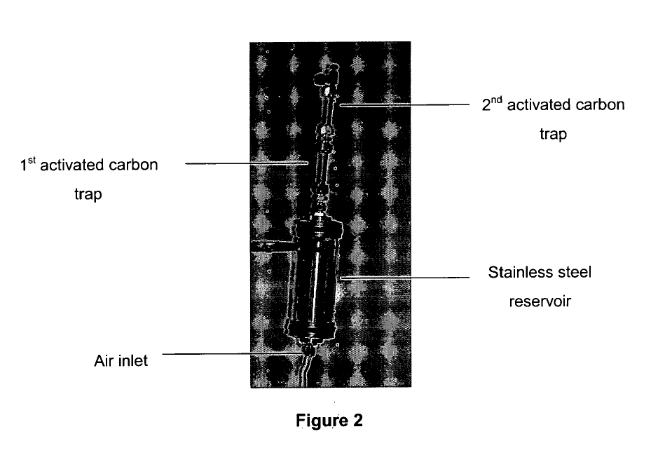

In order to test the potential for recycling of the activated carbon, a stream of air was passed through a stainless steel vessel containing cotton wool saturated with HCBD (HCBD reservoir). The HCBD-laden air stream exiting the reservoir continued through 2 activated carbon (200 mg) columns housed in copper tubing (100 mm×2.5 mm) (see FIG. 2). After approximately 24 h, the activated carbon traps were removed and purged with an ethanol/water/VB₁₂ mixture (50 ml, 90:10 ethanol/water, 1 mg/ml).

The eluant was analysed for HCBD concentration (see Table 1). The results show that activated carbon can be recycled at least seven times with no effect on its performance.

### Example 3

### Reduction of HCBD in Ethanol/Water Using Zero-Valent Zinc

A series of experiments were set up to test whether HCBD can be reduced with zinc in ethanol without the addition of water, and subsequently what effect increasing water concentration has on the rate of reduction.

Five separate HCBD (100 mg, 0.32 mmol) reductions with zinc (130 mg, 2.0 mmol) with 0%, 1%, 5%, 10% and 20% water in ethanol (total volume= 10 mL) were carried out. The reaction progress was monitored by the reduction in the HCBD peak area over time obtained by GC/MS analysis. Increasing the amount of water in the solvent system increased the reduction rate, i.e. 20% water (0.5 μmol/hr), 10% water (0.06 μmol/hr), 5% water (0.3 μmol/hr).

### Example 4

### Reduction of HCBD in Reused Ethanol/Water Using Zero-Valent Zinc in the Presence of VB₁₂

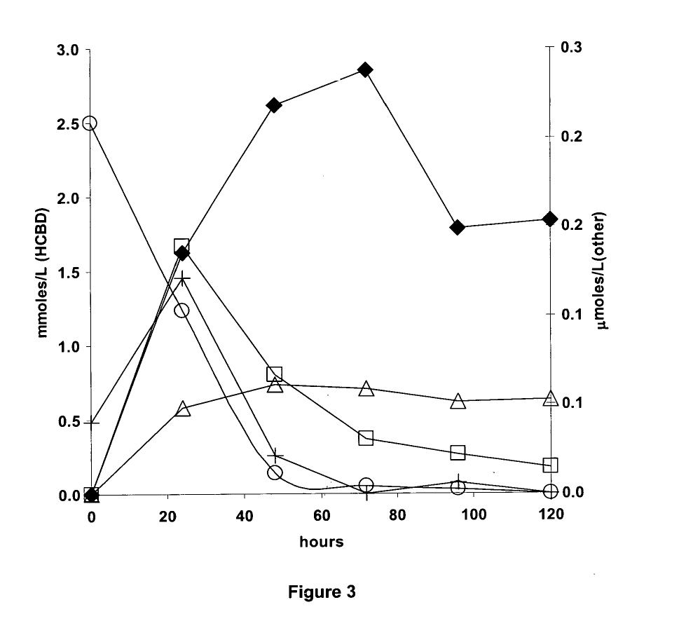

The eluant (50 ml) from an activated carbon column comprising HCBD was charged with zinc powder (115 mg, 2 mmol), degassed and sparged with helium. The decline and accumulation of chlorinated C₄ compounds was observed by GC/MS (see FIG. 3).

While head space analysis by GC/MS showed that 1,3-butadiene was being formed, there also appeared to be the accumulation of partially chlorinated C₄ compounds i.e. tetra and dichloro species (see FIG. 3) at levels of around 10% of the original HCBD concentration. Despite the low concentration of the tetrachloro-(0.1 mmol/L) and dichloro-(0.2 mmol/L) species, the ethanol/water/VB₁₂ solution was reused in a renewed desorption of HCBD from activated carbon (see trial 7, Table 1). There was no obvious depletion of VB₁₂ from the ethanolic solution, and the ability of the solvent to desorb HCBD was not compromised.

This reused solution was annoxically treated with zinc for a second time. Again GC/MS analysis of the reaction vessel headspace showed the major end product to be 1,3-butadiene, together with the dichloro- and tetrachloro-C₄ compounds at low levels. From these observations, it seems that the ethanol/water/VB₁₂ solutions can be recycled repeatedly through the process, and that the used ethanol/water/VB₁₂ solutions have no detrimental effect on the reduction of HCBD.

### Example 5

### Effect of Stirring Rates on Dechlorination

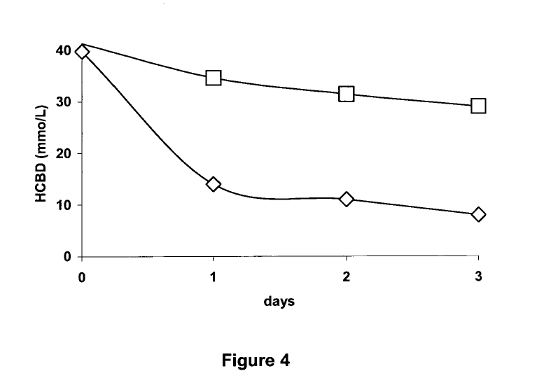

The metal employed in the reductive dechlorination reactions is insoluble, i.e. the reaction mixture is heterogeneous. This raises the possibility of mass transfer limitation. The present experiment was designed to test the significance of the mass transfer of reagents from the alcoholic solution to the zinc surface, where the transfer of electrons takes place. Two identical reduction reactions were set up side by side using HCBD. One reaction was vigorously stirred using a magnetic stirrer, whilst the other was left static without any agitation. The decline in HCBD was monitored by GC/MS every day for 3 days (see FIG. 4). The stirred reaction rate (26 mmol/L/day, measured in terms of HCBD disappearance) was around 9 times faster than the static reaction (3.1 mmol/L/day).

### Example 6

### Optimisation of VB₁₂ Concentration

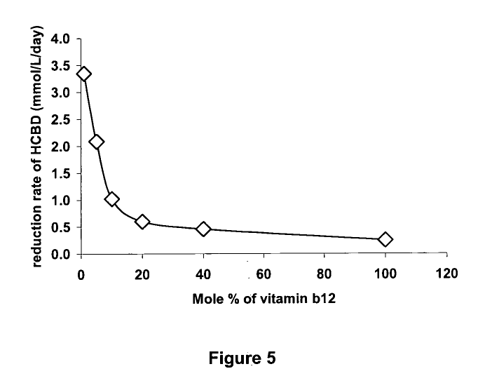

Ethanol/water solutions (50 ml) of HCBD (4 mmol/L) were anoxically reacted with zinc (150 mg, 2.3 mmol). The initial molar ratio of VB₁₂ to HCBD was varied at 0%, 5%, 10%, 20%, 40% and 100 mole % in the six trials (see FIG. 5). The HCBD concentration was monitored daily by GC/MS for 7 days. The results indicated that lower molar ratios of VB₁₂ produced faster HCBD reduction rates (see FIG. 5). The results are surprising, as a decrease in mediator would be expected to decrease, rather than increase the reaction rate. Perhaps the data should be looked at in terms of molar ratio of zinc to VB₁₂. If there is a large excess of VB₁₂ with respect to zinc, then the proportion of reduced to oxidized species of VB₁₂ will be low. This might lead to electrons being passed from reduced VB₁₂ to oxidized VB₁₂ species instead of to HCBD.

### Example 7

### Optimisation of the Amount of Zinc Required in the Reductive Dechlorination

The purpose of this experiment was to determine the optimal molar ratio of zinc to HCBD so as to maximize complete dechlorination of HCBD, and also observe the effect of increasing zinc surface area on the rate of HCBD reduction. To achieve complete dechlorination of HCBD, the molar ratio of zinc:HCBD is theoretically six. Seven HCBD dechlorination trials were setup varying only in the amount of zinc employed. Molar equivalents of zinc to HCBD were: 0, 0.5, 1, 2, 5, 10, 15.

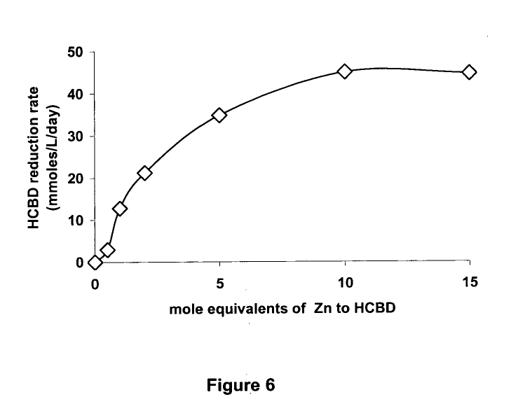

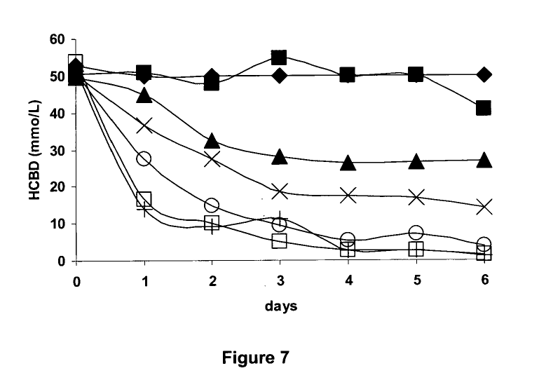

Analysis of HCBD concentrations in each trial after 24 h showed that the reaction rate reached a maximum at around 10 mol equivalents of zinc/HCBD (see FIG. 6). When looking at the sum of all detectable chlorinated C₄ compounds over time (see FIG. 7) greater than 90% were removed with 5 mol equivalents of zinc, and greater than 98% were removed with at least 10 mole equivalents of zinc. With equal mol equivalents (zinc/HCBD ratio of 6) between 40% and 50% of dechlorination was observed, demonstrating that almost half of the zinc electrons were used for dechlorination and not side reactions. Therefore, in summary, no more than about 10 mol equivalents of Zn to HCBD are required to give optimal reaction rate and overall removal of chlorinated C₄ species.

### Example 8

### Effect of Temperature on Zinc-Mediated Dechlorination of HCBD

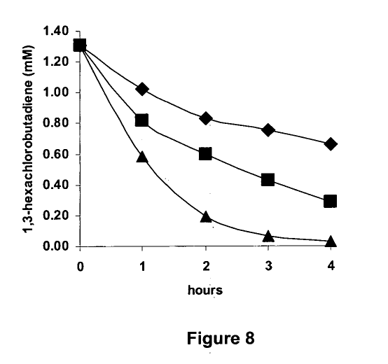

3×100 ml anaerobic dechlorination reactions were established using ethanol/water (90:10, 50 ml, degassed), HCBD (16 mg, 0.065 mmol), and zinc (150 mg, 2.3 mmol). Each of the 3 reaction vessels were treated at the following temperatures: ambient, 37° C. and 55° C. Analysis of HCBD disappearance by GC/MS demonstrated that increased temperature had a positive effect on the initial rate of reaction i.e. 0.29, 0.49 and 0.74 mmol/L/hour, respectively (see FIG. 8).

### Example 9

### Effect of pH on Zinc-Mediated Dechlorination of HCBD

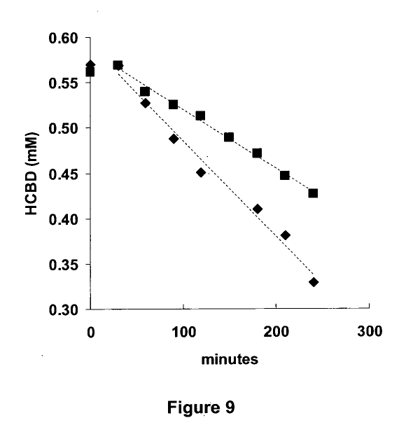

The effect of pH on the dechlorination of HCBD was determined as follows. The pH of a 90% ethanol/water mixture comprising HCBD was lowered to 5 by the addition of ammonium chloride (100 mM), and the dechlorination reaction performed by addition of zinc as described above (i.e., 1 g zinc, 20 μM VB₁₂, 55° C.). When depletion of HCBD (0.6 M) under these conditions was compared to that of an identical reaction at neutral pH there was a 1.6 fold increase in the reaction rate (see FIG. 9).

### Example 10

### Dechlorination of Hexachlorobenzene in the Presence of Co Salen

Dechlorination of hexachlorobenzene (20 mg, 0.06 mmol.) with zinc (160 mg, 2.5 mmol) in a 90% ethanol/water mixture (50 mL) was performed in the presence of cobalt salen at various concentrations (i.e. 0, 1, 2, 5, 10, 25, 50, 100, 250 mg/ml). After 7 days minimal quantities of pentachloro, tetra chloro and trichloro benzene were detected.

### Example 11

### Dechlorination of HCBD with Sodium Borohydride in the Presence of VB₁₂

NaBH₄ (300 mg, 7.7 mmol. (equivalent to 1 g of Zn with respect to electron delivery)), and a 90% ethanolic solution of VB₁₂ (20 μM) were combined in a 50 ml culture flask. The headspace was flushed with nitrogen and the reaction initiated by the addition of HCBD (8 mg, 0.6 mM) through a septum. The VB₁₂ solution became blue almost immediately indicating rapid reduction to the Co(I) state. The reaction mixture was sub-sampled (1 mL) every two minutes. The sub samples were plunged into dilute hydrochloric acid (2 ml) to quench excess hydride. The resulting solutions were then extracted with hexane in order to recover the organochlorides which were analysed by GC/MS.

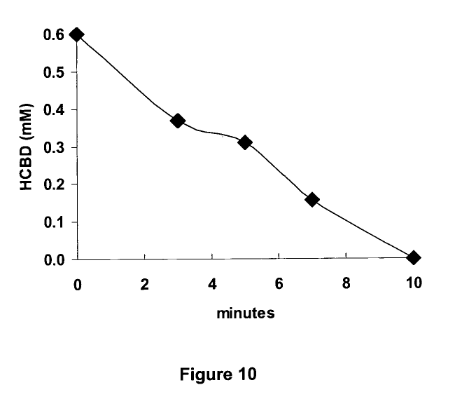

The results (see FIG. 10) demonstrate an extremely vigorous reaction with complete removal of HCBD in only 10 minutes (−0.06 mM/minute). This rate is 18 times faster than the equivalent reaction where zinc is used as the reducing agent.

### Example 12

### Dechlorination of HCBD with Zinc in the Presence of Phenazine and Neutral Red

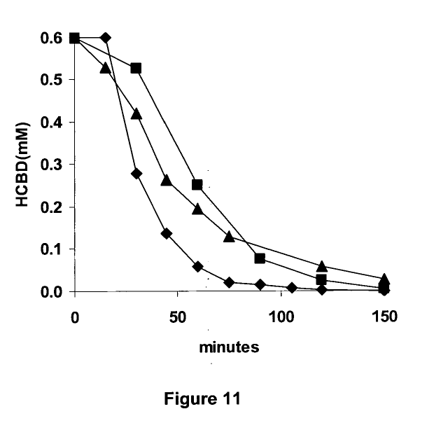

Into 2×50 ml culture flasks was placed zinc (1.0 g, 15.4 mmol) and 90% ethanol (50 ml). The flasks were then charged with either phenazine (1.2 mg, 100 μM) or neutral red (1.0 mg, 100 μM). The flasks were purged with nitrogen and the reaction was initiated by the addition of HCBD (8 mg, 0.6 mM) through a rubber septum. Samples (1 mL) were taken every 15 minutes and analysed in terms of HCBD concentration. Both reactions resulted in complete removal of HCBD in a first order fashion at rates slightly faster than those exhibited when using VB₁₂ (see FIG. 11).

### Example 13

### Dechlorination of Perchloroethylene and Carbon Tetrachloride with Zinc in the Presence of Neutral Red

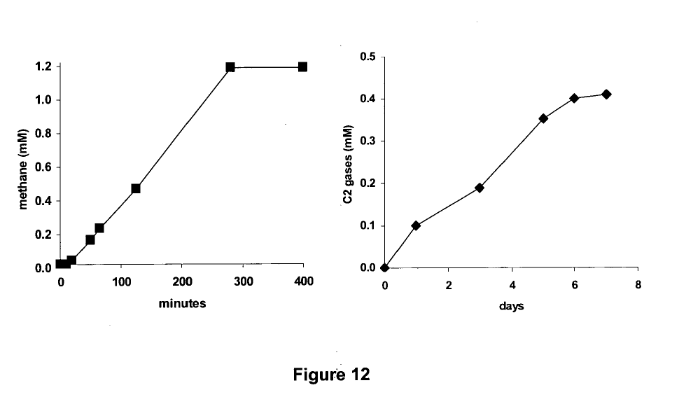

A mixture of carbon tetrachloride (1 mM) and perchloroethylene (1 mM) in 90% ethanol (50 ml) was treated with zinc (1.0 g, 15.4 mmol) and neutral red (100 μM). The reaction head space was monitored by GC/MS which showed the production of innocuous hydrocarbons (see FIG. 12), i.e. methane (0.2 mM/hour) from carbon tetrachloride and ethene and acetylene (0.14 mM/day) from perchloroethylene.

### Example 14

### Dechlorination of HCBD in the Presence of Zinc in Different Solvents

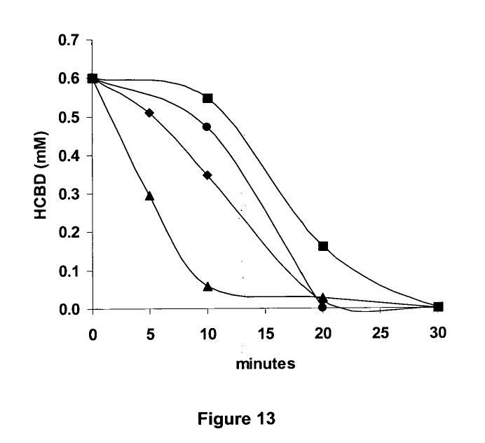

The dechlorination reaction was run in the following organic solvents: isopropanol, dimethylformamide, acetone and acetonitrile. In each case the required solvent (45 ml) containing water (5 ml), VB₁₂ and HCBD (8 mg, 0.6 mmol) was treated with zinc (1.0 g, 15.4 mmol) under an atmosphere of nitrogen at 60° C. The disappearance of HCBD was monitored by GC/MS at regular intervals. The data indicates that any of the above solvents may be used successfully (see FIG. 13).

### Example 15

### Dechlorination of HCBD in the Presence of Mediators Comprising a Quinone Moiety

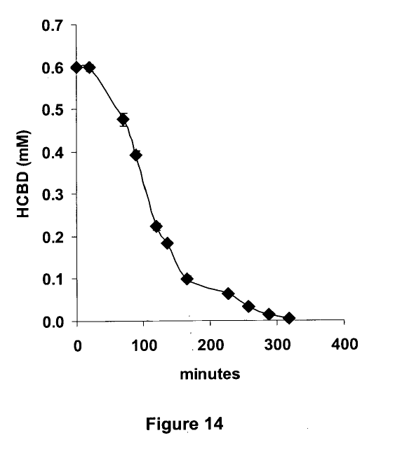

Reduction of HCBD was carried out in the presence of the quinone-containing compound anthraquinone-2,6-disulfonate (AQDS) as follows. 90% ethanol (50 ml) containing AQDS (100 μM) and HCBD (8 mg, 0.6 mM) was treated with zinc (1.0 g, 15.4 mmol) at 55° C. under an inert atmosphere. As seen in FIG. 14, all of the HCBD was consumed after about 5 hours.

Those skilled in the art will appreciate that the invention described herein is susceptible to variations and modifications other than those specifically described. It is to be understood that the invention includes all such variations and modifications.

TABLE 1
Results from 7 “recycles” of a single activated carbon trap.

| | | | | | | | | | | | | | trial 7 | |
|---|---|---|---|---|---|---|---|---|---|---|---|---|---|---|
| compound | trial 1 | | trial 2 | | trial 3 | | trial 4 | | trial 5 | | trial 6 | | | filter |
| name | filter 1 | filter 2 | filter 1 | filter 2 | filter 1 | filter 2 | filter 1 | filter 2 | filter 1 | filter 2 | filter 1 | filter 2 | filter 1* | 2 |
| perchlororethene | 2.9 | 0 | 1.1 | 0 | 2.4 | 0 | 0.8 | 0.0 | 0.4 | 0.0 | 0.3 | 0.0 | 0.2 | 0.0 |
| Tetrachloroethane | 0.2 | 0 | 0.0 | 0 | 0.1 | 0 | 0.1 | 0.0 | 0.1 | 0.0 | 0.1 | 0.0 | 0.1 | 0.0 |
| pentachloroethane | 0.6 | 0 | 0.1 | 0 | 0.8 | 0 | 0.7 | 0.1 | 0.4 | 0.0 | 0.6 | 0.0 | 0.5 | 0.0 |
| hexachloroethane | 1.0 | 0 | 0.2 | 0 | 1.6 | 0 | 1.8 | 0.3 | 1.0 | 0.0 | 2.1 | 0.0 | 1.2 | 0.0 |
| 1,2HCBD | 0.4 | 0 | 0.1 | 0 | 0.4 | 0 | 0.9 | 0.0 | 0.6 | 0.0 | 0.8 | 0.2 | 0.5 | 0.0 |
| 1,3HCBD | 22.5 | 0 | 6.9 | 0 | 25.7 | 0 | 44.1 | 2.2 | 34.8 | 0.7 | 36.3 | 0.2 | 38.0 | 0.2 |
| total | 27.5 | 0 | 8.5 | 0 | 31.1 | 0 | 48.3 | 2.7 | 37.4 | 0.7 | 40.2 | 0.5 | 40.4 | 0.3 |

| | | | | | | | |
|---|---|---|---|---|---|---|---|
| % break through | 0 | 0 | 0 | 5.6 | 1.9 | 1.2 | 0.8 |
| flow rate | 30 | 15 | 30 | 40 | 40 | 40 | 40 |
| (ml/min) | | | | | | | |
| time (h) | 20 | 26 | 21 | 21 | 20 | 19 | 19 |
| volume of gas (L) | 36 | 23 | 38 | 50 | 48 | 46 | 46 |

The numbers given under “filter 1” and “filter 2” are in milligrams.

1. A process for dehalogenation of a halogenated hydrocarbon, said process comprising:
(i) desorbing a halogenated hydrocarbon from a solid phase using a solvent; and
(ii) dehalogenating the halogenated hydrocarbon in a solvent which comprises the solvent used in step (i).

2. The process of claim 1, wherein the solid phase is activated carbon.

3. The process of claim 1, wherein the halogenated hydrocarbon is a chlorinated hydrocarbon.

4. The process of claim 1, wherein the solvent is a protic solvent or an aqueous solvent mixture.

5. The process of claim 4, wherein the solvent is an aqueous solvent mixture.

6. The process of claim 1, wherein the process is carried out at acidic pH.

7. The process of claim 1, wherein step (ii) is carried out in the presence of an electron mediator.

8. The process of claim 7, wherein the electron mediator is vitamin B₁₂, or an analogue or derivative thereof.

9. The process of claim 5, wherein the aqueous solvent mixture is a mixture of water and an organic solvent that is miscible with water.

10. The process of claim 9, wherein the mixture of water and the organic solvent comprises between about 60% and about 99% of the organic solvent (v/v).

11. The process of claim 10, wherein the mixture of water and the organic solvent comprises between about 80% and about 95% of the organic solvent (v/v).

12. The process of claim 9, wherein the organic solvent is an alcohol.

13. The process of claim 12, wherein the alcohol is an alcohol having between 1 and 10 carbon atoms.

14. The process of claim 7, wherein the solvent of step (i) comprises the electron mediator.

15. The process of claim 1, wherein the solvent of step (ii) is reused subsequently when the process is repeated.

16. The process of claim 1, wherein the solid phase is reused subsequently when the process is repeated.

17. The process of claim 1, wherein the halogenated hydrocarbon is a volatile halogenated hydrocarbon.

18. The process of claim 1, wherein the dehalogenation in step (ii) is carried out using a zero-valent transition metal.

19. The process of claim 18, wherein the dehalogenation in step (ii) is carried out using iron or zinc metal.

20. The process of claim 1, wherein the dehalogenation in step (ii) is carried out using borohydride.

21. The process of claim 1, further comprising the step of removing the halogenated hydrocarbon from an environment such that the halogenated hydrocarbon becomes adsorbed to the solid phase.

22. The process of claim 21, wherein the environment is soil.
